(19) United States
(12) Patent Application Publication
(10) Pub. No.: US 2012/0330703 A1
(43) Pub. Date: Dec. 27, 2012

(54) MIGRATING BUSINESS PROCESS INSTANCES

(75) Inventors: Dennis Hohmann, Steinenbronn (DE); Michael Illiger, Haiterbach (DE); Simon Moser, Stuttgart (DE)

(73) Assignee: International Business Machines Corporation, Armonk, NY (US)

(21) Appl. No.: 13/493,012

(22) Filed: Jun. 11, 2012

(30) Foreign Application Priority Data
Jun. 27, 2011 (EP) 11171576.9

(51) Int. Cl. G06Q 10/06

(52) U.S. Cl. 705/7.11

(57) ABSTRACT

Migration of a business process instance derived from a business process model having compensation logic is provided. A new business process version of the business process model is modeled. The business process model is statically analyzed to create a static process control flow. A potential compensation control flow is derived based on the business process instance. Changes between the new business process version and a previous business process version of the business process model are identified. The identified changes are walked to separate and group changes related to the compensation logic and changes related to a normal control flow of the business process model into change groups. The business process instance is migrated based on migration conditions which are determined based on the change groups.

### PRIORITY

The present application claims priority to European Patent Application No. 11171576.9, filed on Jun. 27, 2011, and all the benefits accruing therefrom under 35 U.S.C. §119, the contents of which in its entirety are herein incorporated by reference.

### BACKGROUND

The present invention relates to business process management systems (BPMS) and/or workflow management systems. More specifically, the present invention relates to migrating business process instances.

In a BPMS, a business process template may be perceived as a graph which represents the ordering of steps and/or activities involved in a business process, together with a description of other properties. Every time a business case is initiated, a new instance of the business process is created, based on the underlying business process model. Since business process instances are often long-running in nature, it becomes evident that changes might be required to the business process model, resulting in a new model. This may impact instances still in-flight that were created based on the original associated process model. The reasons for such changes are varied, for example, emerging business opportunities, changing market conditions or new government regulations can force a company to adjust a business process model.

The issue of migrating process instances that were started on the original version of the process model, when the process model evolved, exists and has been partially solved in prior art.

Presently, business processes can only be migrated if the business process does not contain any compensation logic. Compensation can be seen as an “undoing action”, e.g., when an activity of the process has charged a credit card and fails subsequently to deliver the order, compensation should take care of refunding the money (i.e., undoing the credit card charge). More precisely, compensation logic is executed when a state is reached in a process that is deemed to be undesirable. The compensation logic is also executed if an unforeseen error occurred. Errors of such nature are normally caused by malfunctions of the underlying infrastructure. In such cases it may be necessary to perform explicit compensation steps in the business process to assure that a consistent state is reached. The goal is not always to return to a previous condition, but instead to maintain a balanced and consistent state for the process. As such, compensation logic is usually not modeled as part of regular control flow of a business process, but rather as a “compensation flow” that only gets entered under certain (error) conditions.

It would be useful to support process instance migration for such processes, too. In order to show why this is not presently possible, a prior art migration decision process is described as follows.

Referring to FIGS. 2 to 5, a prior art approach of migrating business process instances is described. FIG. 2 shows a process A that includes a linear sequence of four activities A1, A2, A3, A4 that are referred to as original process model A. FIG. 3 shows an evolved process model A′ in which activities A5, A6 and A7 and corresponding links have been inserted. A difference between process A and process A′ is calculated and grouped into one or more so-called “change groups”. A change group is a set of activities that marks the boundaries of a change region. In the depicted example, the region after activity A1 and before activity A4 in FIG. 3 is affected by the change. FIG. 4 shows an instance I′ based on the process A shown in FIG. 2 and stands at activity A1. FIG. 5 shows an instance I′ based on the process A shown in FIG. 2 and stands at activity A3. This illustrates how a check of whether instance I, I′ can be migrated or not may be implemented. For the implementation, a change group CG or change region and a so-called wavefront W is used. The wavefront W is a set of activities that represent “the present position” of the process instance I, I′, i.e., the ‘point of migration’. However, since business processes are parallel in nature, the ‘point of migration’ is not necessarily a singular point, but is rather determined by the wavefront W. In the examples shown in FIGS. 4 and 5, the wavefront W includes activity A1 in FIG. 4, or A3 in FIG. 5, respectively. The criterion to decide whether a given change group CG is compliant with the corresponding instance I, I′ is that the wavefront W must not intersect the change group CG. In the example, the instance I shown in FIG. 4 would be migrateable, because it is not intersecting the change group CG, and the instance I′ shown in FIG. 5 would not be migrateable, because it is intersecting the change group CG.

Returning to compensation, it becomes clear that deciding whether an instance can be migrated or not may be difficult, because a check of whether an instance can be migrated or not is performed statically on a process template, and compensation logic usually results in a derivation from the predefined control flow, making a static check more or less useless.

In U.S. Patent Application Publication No. 2010/0121668 A1 “Automated Compliance Checking for Process Instance Migration” by Hohmann, a business process workflow editorial data processing system is disclosed. The disclosed system can include a workflow management system such as a process editing tool and a repository of templates each template defining a process. At least two of the templates can include a new template and an existing template for an executing instance of a business process. The system can also include compliance checking logic coupled to the workflow management system. The logic can include program code enabled to derive a log of changes between the new template and the existing template based upon added and removed activities and links between activities in the executing process instance, to group the changes in the log according to common activities, to determine a wavefront for the executing process instance, and to migrate the executing process instance to the new template only if the wavefront does not cross any of the groups of the changes, but otherwise rejecting a migration of the process instance to the new template. The disclosed system covers the analysis and compliance check for business processes which do not contain compensation logic.

Existing approaches in the area of instance migration cannot deal with process instances which contain compensation logic effectively. The main difference is that compensation logic enables the underlying workflow management system to derivate from the predefined control flow logic at arbitrary positions. The approach mentioned in U.S. Patent Application Publication No. 2010/0121668 is based mainly on template information and therefore ineffective when dealing with compensation logic since it cannot be statically determined whether logic was actually performed or not. Therefore, this would result in more instances which are rated incorrectly as “incompliant”.

### SUMMARY

According to exemplary embodiments, a method, system, and computer program product for migrating a business process instance derived from a business process model having compensation logic are provided. The method includes modeling a new business process version of the business process model. The business process model is statically analyzed to create a static process control flow. A potential compensation control flow is derived based on the business process instance. Changes between the new business process version and a previous business process version of the business process model are identified. The identified changes are walked to separate and group changes related to the compensation logic and changes related to a normal control flow of the business process model into change groups. The business process instance is migrated based on migration conditions which are determined based on the change groups.

The system for migrating a business process instance derived from a business process model having compensation logic includes a modeling-tool configured to model a new business process version of the business process model. The system also includes a deployment infrastructure configured to install the business process model onto at least one server and communicate with at least one client, allowing the at least one client to interact with the business process model. The system further includes a data processing engine configured to interpret and execute the business process instance by navigating a flow described in the business process model, where the data processing engine is further configured to perform a method. The method includes statically analyzing the business process model to create a static process control flow. A potential compensation control flow is derived based on the business process instance. Changes between the new business process version and a previous business process version of the business process model are identified. The identified changes are walked to separate and group changes related to the compensation logic and changes related to a normal control flow of the business process model into change groups. The business process instance is migrated based on migration conditions which are determined based on the change groups.

A computer program product for migrating business process instances according to the method is also provided.

### BRIEF DESCRIPTION OF THE SEVERAL VIEWS OF THE DRAWINGS

The drawings referenced in the present application are only used to exemplify typical embodiments of the present invention and should not be considered to be limiting the scope of the present invention.

FIG. 1 is a schematic block diagram of a business process management system (BPMS), in accordance with an embodiment;

FIGS. 2 and 3 are schematic block diagrams of embodiments of business process models;

FIGS. 4 and 5 are schematic block diagrams of embodiments of business process instances;

FIG. 6 is a schematic flow diagram of a method of migrating business process instances, in accordance with an embodiment;

FIG. 7 is a schematic block diagram of a first embodiment of a business process model;

FIG. 8 is a schematic control flow of the first business process model shown in FIG. 7, in accordance with an embodiment;

FIG. 9 is a schematic block diagram of a second embodiment of a business process model;

FIGS. 10 and 11 are schematic control flows of the second business process model shown in FIG. 9, in accordance with embodiments; and

FIGS. 12 to 17 are schematic potential compensation control flows of different states of a business process instance derived from the second business process model shown in FIG. 9, in accordance with embodiments.

### DETAILED DESCRIPTION

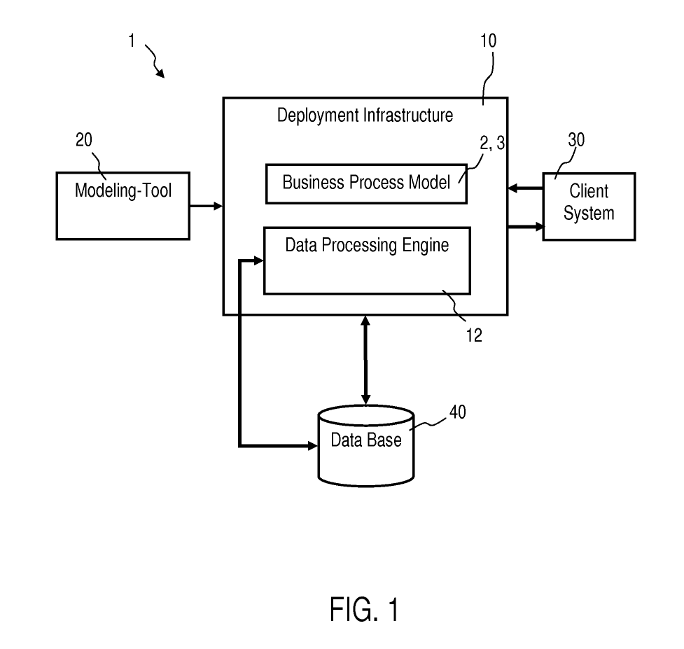

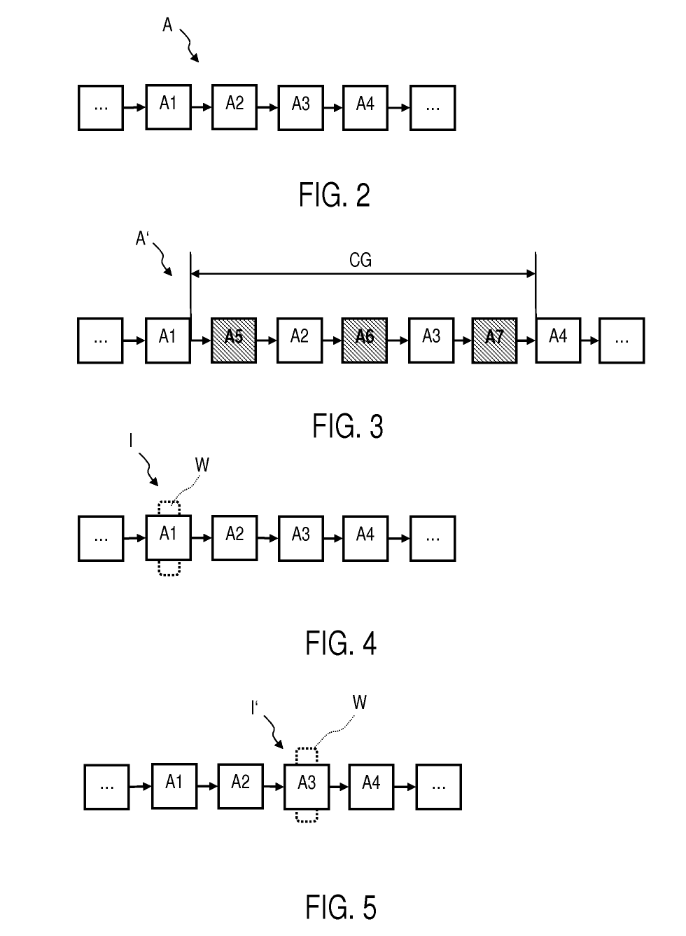

FIG. 1 shows a business process management system (BPMS) 1, in accordance with an embodiment. Referring to FIG. 1, the shown BPMS 1 includes a deployment infrastructure 10, a modeling tool 20, a client system 30, and a data base 40. The modeling tool 20 allows modeling of a business process in a graphical fashion as a business process model 2, 3. The deployment infrastructure 10 includes a data processing engine 12 and installs the business process model 2, 3 onto at least one server, where the business process model 2, 3 becomes a business process template. The client system 30 allows interacting with the business process model 2, 3 (i.e., starting it, sending messages to it, etc.). When a process is started from a business process template, it becomes a business process instance. The data processing engine 12 interprets and executes a business process instance by navigating a graph described in the business process model 2, 3 and/or business process template.

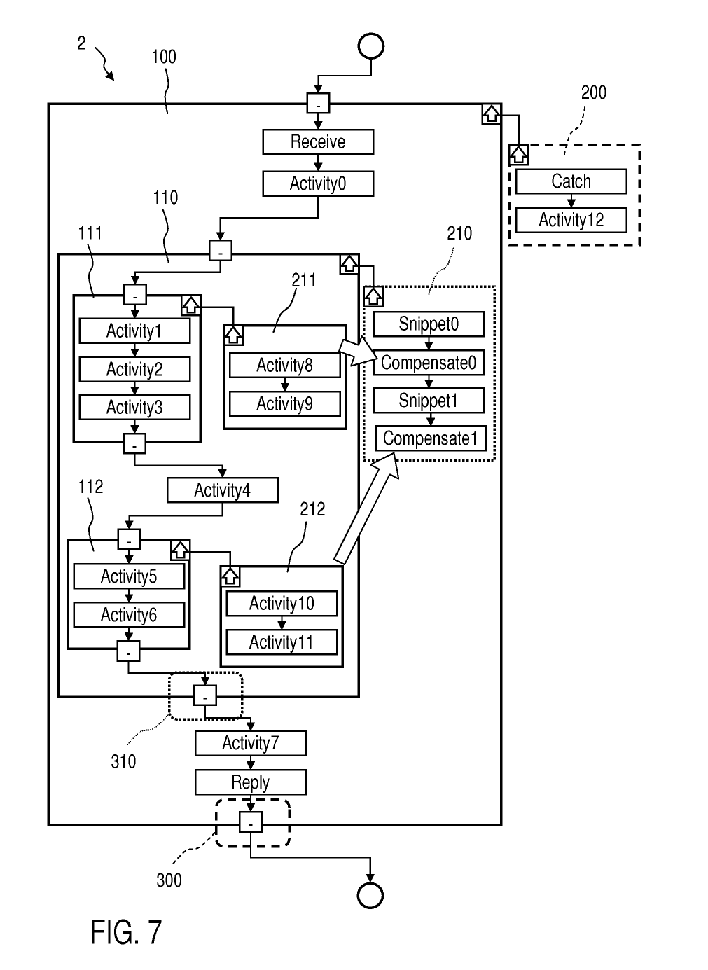

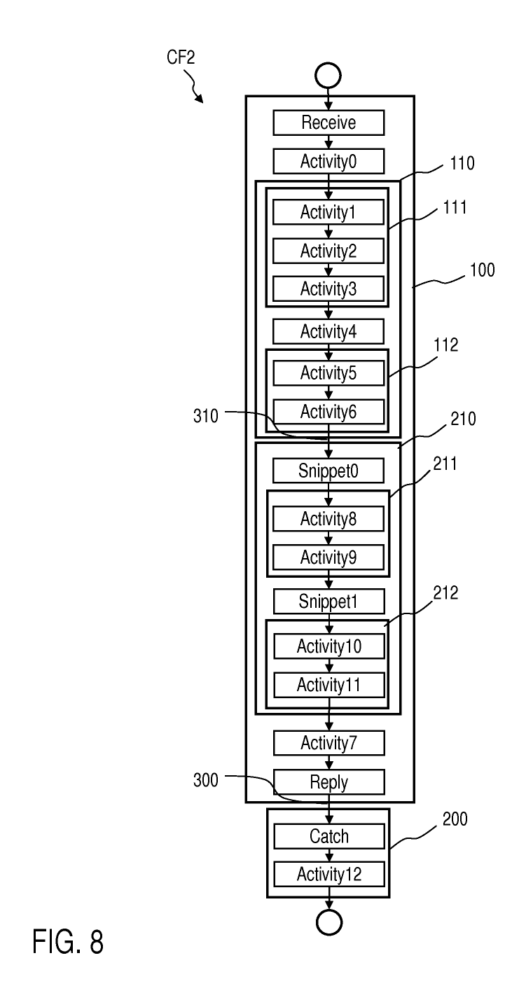

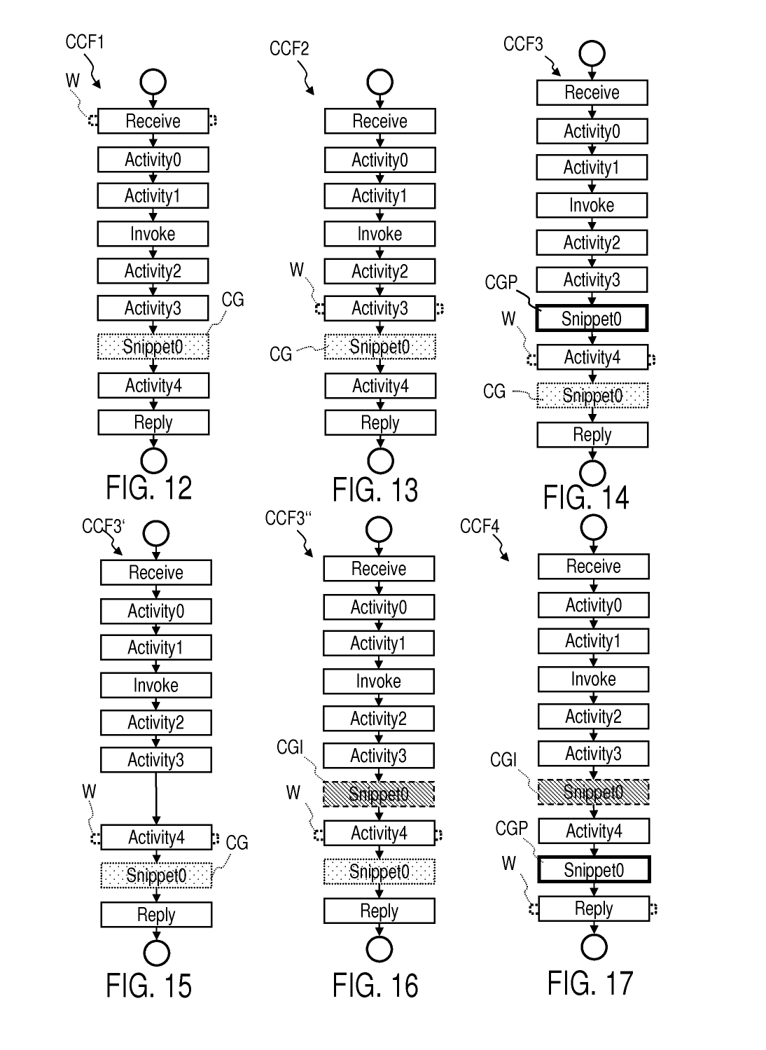

A system of migrating business process instances derived from business process models 2,3 having compensation logic includes: the modeling-tool 20 for modeling a new business process version of a business process model 2, 3; the deployment infrastructure 10 for installing the business process model 2, 3 onto at least one server, communicating with the client system 30 allowing the client system 30 to interact with the business process model 2, 3; and the data processing engine 12 interpreting and executing a process instance by navigating a flow described in the business process model 2, 3. In an embodiment, the data processing engine 12 determines if a corresponding business process instance derived from the business process model 2, 3 is applicable for migration. The data processing engine 12 statically analyzes the business process model 2, 3 to create a static process control flow CF2, CF3, CF3′ of FIGS. 8-11, and derives potential compensation control flows CCF1 to CCF4 of FIGS. 12-17. The data processing engine 12 further identifies changes between a new business process version and a previous business process version, walking the identified changes for separating and grouping changes related to compensation logic 200, 210, 211, 212, 600, 610, 611, 612, 613 of FIGS. 7-11 and changes related to normal control flow 100, 500, 110, 510, 111, 511, 112, 512 of FIGS. 7-11 of the business process model 2, 3 into change groups. The data processing engine 12 also migrates the business process instance based on migration conditions which are determined based on the change groups.

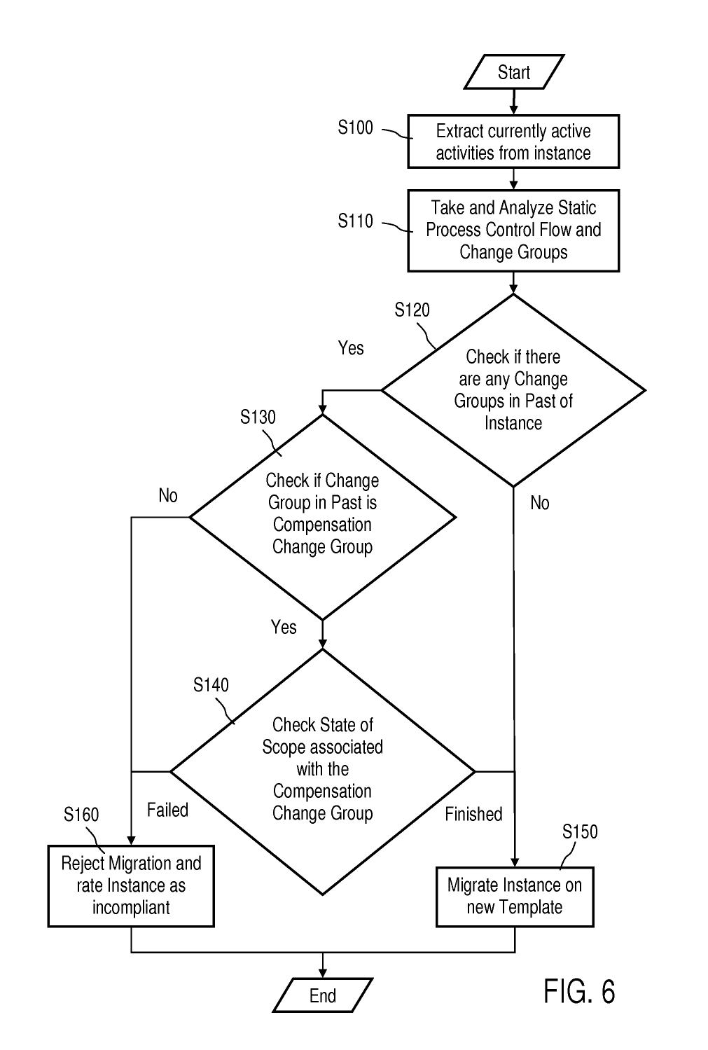

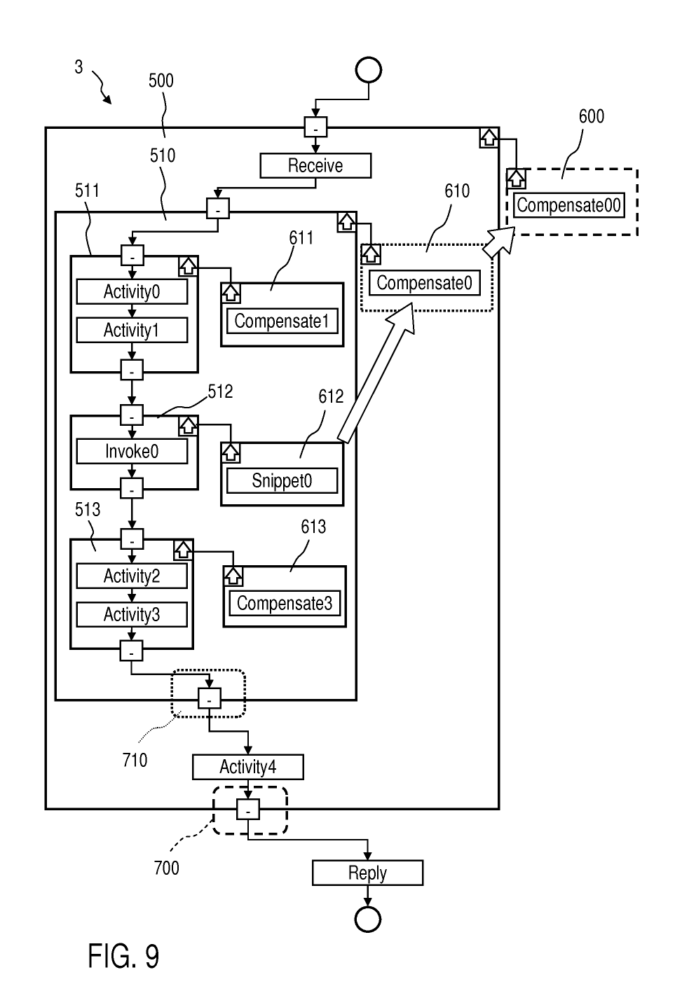

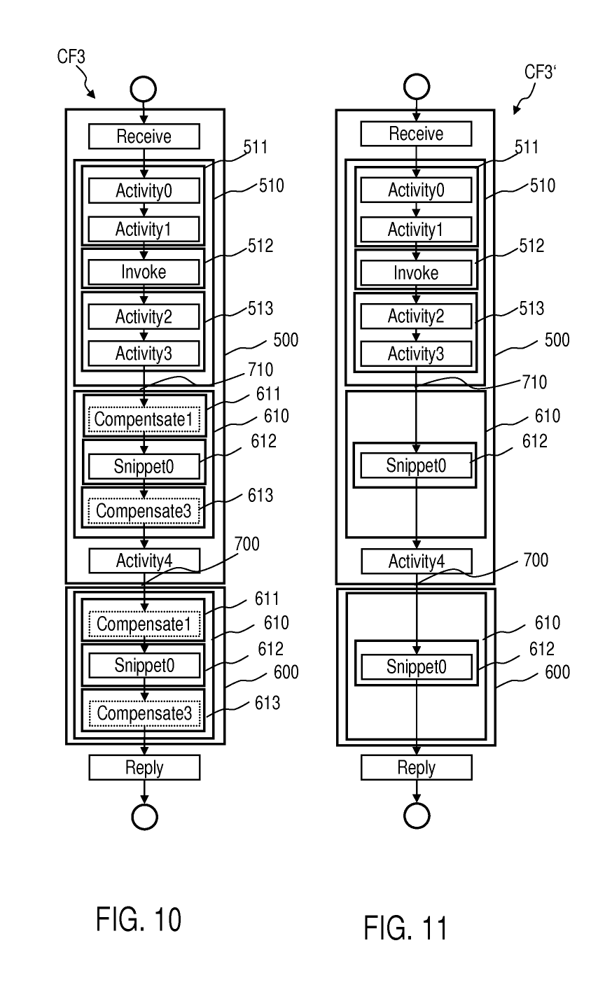

FIG. 6 shows a method of migrating business process instances, in accordance with an embodiment. FIG. 7 shows a first embodiment of a business process model. FIG. 8 shows a control flow of the first business process model shown in FIG. 7, in accordance with an embodiment. FIG. 9 shows a second embodiment of a business process model. FIGS. 10 and 11 show control flows of the second business process model shown in FIG. 9, in accordance with embodiments. FIGS. 12 to 17 show control flows of different states of a business process instance derived from the second business process model shown in FIG. 9, in accordance with embodiments.

Referring to FIG. 6, in block S100 currently active activities from a business process instance are extracted. In block S110 a static process control flow CF2, CF3, CF3′ and change groups are taken and analyzed. In block S120, a check is performed to determine whether or not there are any change groups in the past of the business process instance in view of a current workflow position (i.e., at previous positions). If not, in block S150, the business process instance is migrated on a new business process template. If yes, a check is performed to determine whether or not the change group positioned in the past of the business process instance is a compensation change group. If not, in block S160, migration of the business process instance is rejected and the business process instance is rated as incompliant. If yes, in block S140, a check is performed to determine if a scope associated with the compensation change group is in an end state like “finished” or “completed”, for example, or in an error state like “failed” or “compensated”, for example. If the associated scope is in the end state “finished”, in block S150, the business process instance is migrated on a new business process template. If the associated scope is in the error state “failed”, in block S160, migration of the business process instance is rejected and the business process instance is rated as incompliant.

Referring to FIGS. 7 and 8, an embodiment of business process model 2 contains four units of compensation logic 200, 210, 211, 212. Each unit of compensation logic 200, 210, 211, 212 is associated with a different scope 100, 110, 111, 112 of the business process model 2. Scopes 100 and 110 are examples of areas identified in the business process model 2 which have attached compensation logic 200 and 210. In the example depicted in FIG. 7, the business process model 2 includes a global scope 100 including a first activity “Receive”, a second activity “Activity0”, a local scope 110, a local compensation logic 210 for the local scope 110, a third activity “Activity7” and a fourth activity “Reply”, and a global compensation logic 200 including a fifth activity “Catch”, and a sixth activity “Activity12”. The local scope 110 includes a first inner scope 111 with a seventh activity “Activity1”, an eighth activity “Activity2”, and a ninth activity “Activity3”. The local scope 110 also includes a first inner compensation logic 211 including a tenth activity “Activity8”, and an eleventh activity “Activity9”. For the first inner scope 111, the local scope 110 also includes a twelfth activity “Activity4”, a second inner scope 112 including a thirteenth activity “Activity5”, and a fourteenth activity “Activity6”, and a second inner compensation logic 212 including a fifteenth activity “Activity10”, and a sixteenth activity “Activity11”. The local compensation logic 210 for the local scope 110 includes a seventeenth activity “Snippet0”, an eighteenth activity “Compensate0”, a nineteenth activity “Snippet1” and a twentieth activity “Compensate1”.

During deployment time, the business process model 2 is analyzed statically and potential compensation control flows are derived. The derived compensation control flows are incorporated into the regular control flow CF2 of the business process. First, the inner compensation logic 211, 212 is in-lined in the local compensation logic 210 at corresponding activities “Compensate0”, “Compensate1” where it is called. Therefore, the eighteenth activity “Compensate0” is replaced by the tenth activity “Activity8”, and the eleventh activity “Activity9” forming the first inner compensation logic 211. The twentieth activity “Compensate1” is replaced by the fifteenth activity “Activity10” and the sixteenth activity “Activity11” forming the second inner compensation logic 212. Now the local compensation logic 210 for the local scope 110 includes the activities “Snippet0”, “Activity8”, “Activity9”, “Snippet1”, “Activity10”, and “Activity11”, and the compensation logic for the first inner scope 111 and the second inner scope 112 have been detached.

Next, the local compensation logic 210 for the local scope 110 is detached and inserted in regular control flow CF2 after the local scope 110, yielding a restructured process as shown in FIG. 8. Referring to FIG. 8, the local compensation logic 210 for the local scope 110 is inserted at a logical end 310 of the local scope 110. The global compensation logic 200 is inserted at a logical end 300 of the global scope 100. This restructured process with in-lined compensation logic 200, 210, 211, 212, can now be used to make a static check to decide whether a process instance can be migrated or not using the standard method described in prior art.

Additionally, instance based information can be leveraged to improve accuracy of the migration compliance check (i.e., to reduce the number of false negative results). This is achieved by separating compensation related change logic from changes which affect the standard path, i.e., the normal path which is executed if there are no errors. Therefore, all changes in the compensation logic (i.e., within compensation handler) are grouped into separate change groups (one for each scope of the compensation logic is added during transformation). All changes outside of the compensation logic remain in another change group. This information can then be used in an extended compliance check for compensation changes. If there is a change within a compensation handler then select the direct enclosing scope and check if it is in state finished. If the parent scope is a non-compensable scope then the process may proceed with its parent scope until a compensable scope is found. This assures that modified compensation logic has not been entered yet.

Since compensation logic can potentially be triggered at certain points in the control flow of the process, when the restructured process created with the in-lined compensation logic, certain parts of the compensation logic are duplicated to make sure all the appropriate places where it could get triggered are respected. This handles non-deterministic behavior which comes along with a business process containing compensation logic. It may not be determined statically when the compensation logic is triggered and if it is triggered at all. Each such insertion is called a compensation change group. However, since this is an over-approximation caused by the static nature of the restructuring, only one of the compensation change groups would be valid considering the actual state of a process instance. Thus, when visualizing whether a process instance that contains compensation logic can be migrated or not, the visualization must take that into account.

Referring to FIG. 9, a second embodiment of a business process model 3 contains five units of compensation logic 600, 610, 611, 612, 613. Each unit of compensation logic 600, 610, 611, 612, 613 is scoped to a different scope 500, 510, 511, 512, 513 of the business process model 3. The depicted second embodiment of the business process model 3 includes a global scope 500 including a first activity “Receive”, a local scope 510, a local compensation logic 610 for the local scope 510, a second activity “Activity4”. A global compensation logic 600 including a third activity “Compensate00”. The business process model 3 also includes a fourth activity “Reply”. The local scope 510 includes a first inner scope 511 including a fifth activity “Activity0” and a sixth activity “Activity1”. The local scope 510 also includes a first inner compensation logic 611 including a seventh activity “Compensate1” for the first inner scope 511. The local scope 510 further includes a second inner scope 512 including an eighth activity “Invoke0”. The local scope 510 also includes a second inner compensation logic 612 including a ninth activity “Snippet0” for the second inner scope 512. The local scope 510 includes a third inner scope 513 including a tenth activity “Activity2” and an eleventh activity “Activity3”. The local scope 510 additionally includes a third inner compensation logic 613 including a thirteenth activity “Comensate3” for the third inner scope 513. The local compensation logic 610 for the local scope 510 includes a fourteenth activity “Compensate0”.

Referring to FIG. 10, in a regular control flow CF3 of the business process model 3 derived compensation control flows is incorporated. The inner compensation logic 611, 612, 613 are in-lined in the local compensation logic 610 at the corresponding activity “Compensate0”. Therefore, the fourteenth activity “Compensate0” is replaced by the seventh activity “Compensate1”, the ninth activity “Snippet0”, and the thirteenth activity “Compensate3” forming the first, second and third inner compensation logic 611, 612, 613, respectively. Also, the third activity “Compensate00” of the global compensation logic 600 is replaced by the fourteenth activity “Compensate0” of the local compensation logic 610 which is in turn replaced by the seventh activity “Compensate1”, the ninth activity “Snippet0”, and the thirteenth activity “Compensate3” forming the first, second and third inner compensation logic 611, 612, 613, respectively. Now the local compensation logic 610 for the local scope 510 includes the activities “Compensate1”, “Snippet0”, and “Compensate3”, and the compensation logic for the first inner scope 611, the second inner scope 612, and the third inner scope 613 have been detached.

Next, the local compensation logic 610 for the local scope 510 is detached and inserted in regular control flow CF3 after the local scope 510, yielding the restructured process shown in FIG. 10. Referring to FIG. 10, the local compensation logic 610 for the local scope 510 is inserted at a logical end 710 of the local scope 510. The global compensation logic 600 for the global scope 500 includes the activities “Compensate)”, “Snippet0”, and “Compensate3”, and the global compensation logic 600 is inserted at a logical end 700 of the global scope 500. This restructured process with in-lined compensation logic 600, 610, 611, 612, 613 can now be used to make a static check to decide whether a process instance can be migrated or not using the standard method described in prior art.

Assuming, that the first inner compensation logic 611 and the third inner compensation logic 613 are empty, which means, that no activities are performed, the regular control flow CF3 may be simplified. The simplified control flow CF3′ is shown in FIG. 11.

Referring to FIG. 11, in the simplified regular control flow CF3′ of the business process model 3, the fourteenth activity “Compensate0” is replaced by the ninth activity “Snippet0”. Also, the third activity “Compensate00” of the global compensation logic 600 is replaced by the fourteenth activity “Compensate0” of the local compensation logic 610 which is in turn replaced by the ninth activity “Snippet0”. Now the local compensation logic 610 for the local scope 510 includes the activity “Snippet0”. Still referring to FIG. 11, the local compensation logic 610 for the local scope 510 is inserted at a logical end 710 of the local scope 510. The global compensation logic 600 for the global scope 500 includes the activity “Snippet0”. The global compensation logic 600 is inserted at a logical end 700 of the global scope 500. The restructured process can be used to decide whether a process instance can be migrated or not.

FIGS. 12 to 17 show potential compensation control flows CCF1, CCF2, CCF3, CCF3′, CCF3″, CCF4 of sample processes with in-lined compensation logic and compensation change groups depending on the state of the process instance. In FIGS. 12 to 17, a compensation change group CG, lying in the future in view of the current state of the process instance which is labeled as wavefront W, is highlighted as a dotted block. A compensation change group CGP, lying in the past in view of the current state of the process instance W is highlighted as block with heavier line weights. A compensation change group CGI lying in the past and being “irrelevant” for the migration process of the process instance is highlighted as a shaded block.

As stated before, the compensation change groups CG, that need to be considered, depend on the current state of the process instance. Referring to FIG. 12, in the depicted first potential compensation control flow CCF1 of the business process instance, the current state of the process instance W is the first activity “Receive” of the global scope 500 in the business process model 3. In the future, only the very next compensation change group CG is of interest. All remaining future compensation change groups are omitted. Therefore, in this state, the next compensation change group CG to be considered in the future is the ninth action “Snippet0” of the second inner compensation logic 612 only. There is no change group CGP in the past in view of the current state of the process instance W. All compensation change groups CGP in the past prevent the instance from being migrateable when having a directly enclosing scope in the state “compensated” or “Failed”.

Referring to FIG. 13, in the depicted second potential compensation control flow CCF2 of the business process instance, the current state of the process instance W is the eleventh activity “Activity3” of the third inner scope 513 in the local scope 510 of the business process model 3. In this state, the next compensation change group CG to be considered in the future is still the ninth action “Snippet0” of the second inner compensation logic 612. There is also no change group CGP in the past in view of the current state of the process instance W.

Referring to FIG. 14, in the depicted third potential compensation control flow CCF3 of the business process instance, the current state of the process instance W is the second activity “Activity4” of the global scope 500 in the business process model 3. In this state, the next compensation change group CG to be considered in the future is the ninth action “Snippet0” of the local compensation logic 610 in the business process model 3. There is a first change group CGP in the past in view of the current state of the process instance W that is to be considered. At this point, a check is performed if the directly associated scope, here the second inner scope 512, is in the state “Compensated/Failed” or “Finished”. Assuming that the second inner scope 512 is in the state “Finished”, which means that the associated second inner compensation logic 612 has not been executed, the first change group in the past CGP is not influencing the compliance check. Therefore, in order to reduce the number of false negative compliance checks it is necessary to reduce the number of compensation change groups CGP in the past. Whenever such a change group CGP is passed the previously described instance based information, i.e., the state of the surrounding scope, here the second inner scope 612, is leveraged to check if this change group CGP can be automatically deleted from the workflow graph as shown in FIG. 15, and thus the compliance check is not influenced by the change group. FIG. 15 shows the optimized potential compensation control flow CCF3′ without the ninth action “Snippet0” of the second inner compensation logic 612. To optimize the business process instance the change group CGP can also be marked as “irrelevant” in case a deletion is expensive depending on the system. FIG. 16 shows the optimized third potential compensation control flow CCF3″ with the ninth action “Snippet0” of the second inner compensation logic 612 as change group CGI marked as “irrelevant”.

Referring to FIG. 17, in the depicted fourth potential compensation control flow CCF4 of the business process instance, the current state of the process instance W is the fourth activity “Reply” of the business process model 3. In this state, there is no next compensation change group CG to be considered in the future. There is a first change group CGP in the past in view of the current state of the process instance W that is marked as “irrelevant” and therefore not influencing the compliance check. Further, there is a second change group CGP in the past in view of the current state of the process instance W. At this point, a check is performed, if the directly associated scope, here the global scope 500, is in the state “Compensated/Failed” or “Finished”. Assuming that the global scope 500 is in the state “Compensated”, which means that the associated global compensation logic 600 has been executed, the second change group in the past CGP is influencing the compliance check. Therefore the migration is rejected and the business process instance is rated as incompliant.

Technical effects of embodiments provide a method of migrating business process instances and a system of migrating business process instances, which are able to migrate business process instances derived from business process models having compensation logic and to solve the above mentioned shortcomings of prior art migrating business process instances.

According to embodiments, a method of migrating business process instances, a system of migrating business process instances, and a computer program product for migrating business process instances is provided.

In an embodiment, a method of migrating business process instances derived from business process models having compensation logic includes modeling of a new business process version and determining if a corresponding business process instance derived from the business process model is applicable for migration. An underlying business process model is statically analyzed to create a static process control flow. Potential compensation control flows are derived and changes between the new business process version and a previous business process version are identified. The identified changes are walked for separating and grouping changes related to compensation logic and changes related to normal control flow of the business process model into change groups. The business process instance is migrated based on migration conditions which are determined based on the change groups.

In further embodiments, static process control flow is extended by incorporating compensation information. In further embodiments, instance related information is attached to the static process control flow. Areas in the business process model are identified which have attached compensation logic. The compensation logic may be disposed to the process control flow at a logical end of the areas, and a resulting modified control flow is then used as input for migration compliance analysis. The migration conditions can be computed by extracting currently active activities from the business process instance; and taking and analyzing the static process control flow and the change groups, where migration of the business process instance is enabled if there is no change group in the past of the static process control flow of the business process instance.

In further embodiments, migration of the business process instance is rejected if there is at least one change group in the past of the static process control flow of the business process instance and if the change group is not a compensation change group. Migration of the business process instance may be enabled if at least one change group in the past of the static process control flow of the business process instance is a compensation change group and a state of a scope associated with the compensation change group is recognized as end state. Migration of the business process instance can be rejected if the at least one change group in the past of the static process control flow of the business process instance is a compensation change group and a state of a scope associated with the compensation change group is recognized as error state.

In another embodiment, a system of migrating business process instances derived from business process models having compensation logic includes a modeling-tool for modeling a new business process version. The system also includes a deployment infrastructure for installing the business process model onto at least one server, and communicating with at least one client allowing the at least one client to interact with the business process. A data processing engine interprets and executes a process instance by navigating a flow described in the business process model, where the data processing engine determines if a corresponding business process instance derived from the business process model is applicable for migration. The data processing engine may statically analyze an underlying business process model to create a static process control flow and derive potential compensation control flows. The data processing engine also identifies changes between the new business process version and a previous business process version. The data processing engine walks the identified changes for separating and grouping changes related to compensation logic and changes related to normal control flow of the business process model into change groups. The data processing engine migrates the business process instance based on migration conditions which are determined based on the change groups.

In further embodiments, the data processing engine extends the static process control flow by incorporating compensation information from a data base. The data processing engine attaches instance related information from the data base to the static process control flow. The data processing engine can identify areas in the business process model which have attached compensation logic, dispose the compensation logic to the process control flow at a logical end of the areas, and use a resulting modified control flow as input for migration compliance analysis.

In another embodiment, a data processing program for execution in a data processing system includes software code portions for performing a method of migrating business process instances when the program is run on the data processing system. In another embodiment, a computer program product stored on a computer-usable medium, includes computer-readable program means for causing a computer to perform a method of migrating business process instances when the program is run on the computer.

The embodiments may address a method or system of associating compensation logic to compensate for the changes indicated by the change groups to the business process instance and deciding whether the business process instances are migrateable or not based on the state of scope associated with the compensation change. Embodiments improve the number of instances which can be migrated.

Embodiments for deciding whether a process instance can be migrated or not for a business process where compensation logic is used may include two actions, plus an additional action to explain this to the user. First, the process model is analyzed and potential compensation control flows are derived, i.e., extending the static process control flow by incorporating compensation information such as credit card transaction information. This is an extension to the deployment infrastructure of the Business Process Management System (BPMS). Next, instance related information is attached to the static process control flow. Compensation logic is defined for a scope, i.e., a part of the control flow which is affected by the modeled compensation logic. Thus, if an unforeseen error occurs within a scope the compensation logic defined for this scope is triggered and the scope enters an error state like “failed” or “compensated” in order to indicate that this scope was not executed and its side effects were compensated. However, if a scope enters an end state such as “finished” or “completed”, it can be assured that the associated compensation logic was not executed, since it is only executed in case of an error. Therefore this information, i.e., the state of the scopes which were already passed, is also extracted from a database and attached to the internal process model. If a scope is in an end state which clearly indicates that there was no compensation logic triggered for this scope, any changes to the compensation logic of this scope can safely be ignored, since the currently running instance cannot be affected. For these scopes, the compensation change groups are removed and not considered for further analysis. Travelling compensation change groups can be visualized, so that the user understands better the extension to the modeling tool or to the client piece of a BPMS.

Embodiments may significantly improve a compliance check and thus make the compliance check more accurate and precise due to incorporating additional process instance based information and compensation information.

The method of migrating business process instances can be implemented as an entirely software embodiment, or an embodiment containing both hardware and software elements. Embodiments can be implemented in software, which includes but is not limited to firmware, resident software, microcode, etc.

Furthermore, embodiments can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disc, and an optical disc. Current examples of optical discs include Compact Disc-read only memory (CD-ROM), Compact Disc-read/write (CD-R/W), and DVD. A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

What is claimed is:

1. A method for migrating a business process instance derived from a business process model having compensation logic, the method comprising:
modeling a new business process version of the business process model;
statically analyzing the business process model to create a static process control flow;
deriving a potential compensation control flow based on the business process instance;
identifying changes between the new business process version and a previous business process version of the business process model;
walking the identified changes to separate and group changes related to the compensation logic and changes related to a normal control flow of the business process model into change groups; and
migrating the business process instance based on migration conditions which are determined based on the change groups.

2. The method of claim 1, wherein the static process control flow is extended by incorporating compensation information.

3. The method of claim 1, wherein instance related information is attached to the static process control flow.

4. The method of claim 1, wherein an area in the business process model is identified which has attached compensation logic.

5. The method of claim 4, wherein the compensation logic is inserted in the process control flow at a logical end of the area, and a resulting modified control flow is used as input for migration compliance analysis.

6. The method of claim 1, wherein the migration conditions are computed by extracting currently active activities from the business process instance, and further performing:
taking and analyzing the static process control flow and the change groups, wherein migration of the business process instance is enabled based on no change group at a previous position in the past of the static process control flow of the business process instance.

7. The method of claim 6, wherein migration of the business process instance is rejected based on at least one change group in the past of the static process control flow of the business process instance and the at least one change group is not a compensation change group.

8. The method of claim 7, wherein migration of the business process instance is enabled based on determining that the at least one change group in the past of the static process control flow of the business process instance is the compensation change group, and a state of a scope associated with the compensation change group is recognized as an end state.

9. The method of claim 7, wherein migration of the business process instance is rejected based on determining that the at least one change group in the past of the static process control flow of the business process instance is the compensation change group, and a state of a scope associated with the compensation change group is recognized as an error state.

10. A system for migrating a business process instance derived from a business process model having compensation logic, the system comprising:
a modeling-tool configured to model a new business process version of the business process model;
a deployment infrastructure configured to install the business process model onto at least one server and communicate with at least one client, allowing the at least one client to interact with the business process model; and
a data processing engine configured to interpret and execute the business process instance by navigating a flow described in the business process model, wherein the data processing engine is further configured to perform a method comprising:
statically analyzing the business process model to create a static process control flow;
deriving a potential compensation control flow based on the business process instance;
identifying changes between the new business process version and a previous business process version of the business process model;
walking the identified changes to separate and group changes related to compensation logic and changes related to a normal control flow of the business process model into change groups; and
migrating the business process instance based on migration conditions which are determined based on the change groups.

11. The system of claim 10, wherein the data processing engine extends the static process control flow by incorporating compensation information from a data base.

12. The system of claim 10, wherein the data processing engine attaches instance related information from the data base to the static process control flow.

13. The system of claim 10, wherein the data processing engine identifies an area in the business process model which has attached compensation logic, inserts the compensation logic into the process control flow at a logical end of the area, and uses a resulting modified control flow as input for migration compliance analysis.

14. A computer program product for migrating a business process instance derived from a business process model having compensation logic, the computer program product comprising:
a computer readable storage medium having computer readable program code embodied therewith, the computer readable program code comprising:
computer readable program code configured to perform:
statically analyzing the business process model to create a static process control flow;
deriving a potential compensation control flow based on the business process instance;
identifying changes between a new business process version and a previous business process version of the business process model;
walking the identified changes to separate and group changes related to the compensation logic and changes related to a normal control flow of the business process model into change groups; and
migrating the business process instance based on migration conditions which are determined based on the change groups.

15. The computer program product of claim 14, wherein the static process control flow is extended by incorporating compensation information.

16. The computer program product of claim 14, wherein instance related information is attached to the static process control flow.

17. The computer program product of claim 14, wherein an area in the business process model is identified which has attached compensation logic.

18. The computer program product according to claim 17, wherein the compensation logic is inserted in the process control flow at a logical end of the area, and a resulting modified control flow is used as input for migration compliance analysis.

19. The computer program product of claim 14, wherein the migration conditions are computed by extracting currently active activities from the business process instance, and further performing:
taking and analyzing the static process control flow and the change groups, wherein migration of the business process instance is enabled based on no change group at a previous position in the past of the static process control flow of the business process instance.

20. The computer program product of claim 19, wherein migration of the business process instance is rejected based on at least one change group in the past of the static process control flow of the business process instance and the at least one change group is not a compensation change group.
